(19) United States
(12) Patent Application Publication
(10) Pub. No.: US 2015/0052484 A1
(43) Pub. Date: Feb. 19, 2015

(54) INFORMATION PROCESSING METHOD AND ELECTRONIC DEVICE

(71) Applicants: Lenovo (Beijing) Co., Ltd., Beijing (CN); Beijing Lenovo Software Ltd., Beijing (CN)

(72) Inventor: Xihuang Huang, Beijing (CN)

(73) Assignees: Lenovo (Beijing) Co., Ltd., Beijing (CN); Beijing Lenovo Software Ltd., Beijing (CN)

(21) Appl. No.: 14/229,868

(22) Filed: Mar. 29, 2014

(30) Foreign Application Priority Data
Aug. 16, 2013 (CN) 201310359354.0

(51) Int. Cl. G06F 3/0481; G06F 3/0484

(52) U.S. Cl. CPC G06F 3/04817; G06F 3/04842
USPC 715/825

(57) ABSTRACT

The present invention discloses an information processing method and an electronic device, where the electronic device has a display unit, status bar information is displayed on the display unit, and a display area of the status bar information is a first display area of the display unit, and the method includes: obtaining an input operation on the first display area; when the input operation is a first input operation, displaying a first notification interface on the display unit in response to the first input operation, wherein the first notification interface includes only prompt information; and when the input operation is a second input operation, displaying a second setting interface on the display unit in response to the second input operation, wherein the second setting interface includes only M application icons, and M is an integer no less than 1.

The present application claims the priority of Chinese Patent Application No. 201310359354.0, entitled as “Information processing method and electronic device”, and filed with the Chinese Patent Office on Aug. 16, 2013, the contents of which are incorporated herein by reference in its entirety.

### FIELD OF THE INVENTION

The present invention relates to the field of computer technologies and in particular to an information processing method and electronic device.

### BACKGROUND OF THE INVENTION

Electronic devices have been increasingly and widely applied in daily life along with their rapid development. The existing electronic devices, e.g., smart phones, PDAs, etc., have become increasingly popularized due to their increasingly enriched functions, such as powerful processing capacity and network access anytime and anywhere, etc, and the existing electronic devices can acquire in real-time a system setting interface including a system status message and a system notification interface including a system notification message to thereby facilitate use by a user and make an experience of the user better.

However there are technical problems of a single opening mode and troublesome operations when the existing electronic devices invoke the system setting interface and the system notification interface, and referring to FIG. 1, when a status bar 21 is displayed on a touch screen 20 of a smart phone and a pull-down operation on the status bar 21 is received, a system notification interface 22 including a system notification message of the smart phone will be displayed on the touch screen 20, and when a system setting interface including a system status message needs to be displayed on the touch screen 20, the system setting interface can only be displayed on the touch screen 20 after another operation of pressing down a key 23 is received, so that the system setting interface can only be displayed on the touch screen 20 by two operations, thus resulting in the technical problems of a single opening mode and troublesome operations when the existing electronic devices invoke the system setting interface and the system notification interface.

### SUMMARY OF THE INVENTION

Embodiments of this application provide an information processing method and electronic device so as to address the technical problems of a single opening mode and troublesome operations when the existing electronic devices invoke a system setting interface and a system notification interface.

An embodiment of this application provides an information processing method, applicable to an electronic device including a display unit, wherein status bar information is displayed on the display unit, and a display area of the status bar information is a first display area of the display unit, and the method includes: obtaining an input operation on the first display area; when the input operation is a first input operation, displaying a first notification interface on the display unit in response to the first input operation, wherein the first notification interface includes only prompt information; and when the input operation is a second input operation, displaying a second setting interface on the display unit in response to the second input operation, wherein the second setting interface includes only M application icons, and M is an integer no less than 1.

Optionally, when the input operation is the first input operation, the displaying the first notification interface on the display unit in response to the first input operation includes: when the input operation is the first input operation on a first part display area of the first display area, displaying the first notification interface including system notification information on the display unit in response to the first input operation.

Optionally, after the first notification interface including the system notification information is displayed on the display unit, the method further includes: obtaining a first switching operation on the first notification interface; and adjusting the display interface of the display unit from the first notification interface to the second setting interface in response to the first switching operation.

Optionally when the input operation is the second input operation, the displaying the second setting interface on the display unit in response to the second input operation includes: when the input operation is the second input operation on a second part display area of the first display area, displaying the second setting interface on the display unit in response to the second input operation, wherein the second part display area is an area different from the first part display area.

Optionally, after the second setting interface is displayed on the display unit, the method further includes: obtaining a second switching operation on the second setting interface; and adjusting the display interface of the display unit from the second setting interface to the first notification interface in response to the second switching operation.

Optionally, when the second setting interface is displayed on the display unit, the method further includes: obtaining a first operation on a first application icon of the M application icons; and displaying a setting interface of a first application corresponding to the first application icon on the display unit in response to the first operation.

An embodiment of this application provides an electronic device including: a circuit board; a display unit electrically connected with the circuit board, configured to display status bar information, wherein the display area of the status bar information is a first display area of the display unit; and a processing chip, arranged on the circuit board, configured to obtain an input operation on the first display area, when the input operation is a first input operation, to display a first notification interface on the display unit in response to the first input operation, wherein the first notification interface includes only prompt information, and when the input operation is a second input operation, to display a second setting interface on the display unit in response to the second input operation, wherein the second setting interface includes only M application icons, and M is an integer no less than 1.

Optionally, the processing chip includes a first obtaining unit configured, when the input operation is the first input operation on a first part display area of the first display area, to display the first notification interface including system notification information on the display unit in response to the first input operation.

Optionally, the processing chip includes a first switching unit configured, after the first notification interface including the system notification information is displayed on the display unit, to obtain a first switching operation on the first notification interface and to adjust the display interface of the display unit from the first notification interface to the second setting interface in response to the first switching operation.

Optionally, the processing chip includes a second obtaining unit configured, when the input operation is the second input operation on a second part display area of the first display area, to display the second setting interface on the display unit in response to the second input operation, wherein the second part display area is an area different from the first part display area.

Optionally, the processing chip includes a second switching unit configured, after the second setting interface is displayed on the display unit, to obtain a second switching operation on the second setting interface and to adjust the display interface of the display unit from the second setting interface to the first notification interface in response to the second switching operation.

Optionally the processing chip includes a first processing unit configured, when the second setting interface is displayed on the display unit, to obtain a first operation on a first application icon of the M application icons and to display a setting interface of a first application corresponding to the first application icon on the display unit in response to the first operation.

One or more of the technical solutions according to the embodiments of this application have at least the following technical effects or advantages:

Firstly, since in the embodiments of this application, the status bar information is displayed on the display unit, and when the display area of the status bar information is the first display area of the display unit, the input operation on the first display area is obtained, and when the input operation is the first input operation, the first notification interface including only the prompt information is displayed on the display unit, and when the input operation is the second input operation, the second setting interface including only the M application icons is displayed on the display unit, so that the user can view the first notification interface and the second setting interface through the different input operations, thereby addressing the technical problems of a single opening mode and troublesome operations when the existing electronic devices invoke a system setting interface and a system notification interface, and further achieving technical effects of invoking the system setting interface and the system notification interface in numerous modes and of simplifying operation steps, so that the user can make more convenient use and have a better experience thereof.

Secondly, since in the embodiments of the invention, when the input operation is the first input operation on the first part display area of the first display area, the first notification interface is displayed on the display unit, and when the input operation is the second input operation on the second part display area of the first display area, the second setting interface is displayed on the display unit, and since the first part display area is different from the second part display area, thus the electronic device can recognize accurately the first input operation and the second input operation to lower the probability of an improper operation, so that the user can make more convenient use and have a better experience thereof.

Thirdly since in the embodiments of the invention, after the first notification interface is displayed on the display unit, the first switching operation is performed to adjust the current display interface of the display unit from the first notification interface to the second setting interface, so that switching between the first notification interface and the second setting interface can be performed simply with the first switching operation, and thereby numerous of opening modes are obtained, and the user can make more convenient use and have a better experience thereof.

### BRIEF DESCRIPTION OF THE DRAWINGS

FIG. 1 is a structural diagram of a system notification message displayed on a display unit in the convention;

FIG. 2 is a flow chart of an information processing method according to an embodiment of this application;

FIG. 3 is a structural diagram of status bar information displayed on a display unit according to an embodiment of this application;

FIG. 4 is a structural diagram of a first notification interface displayed on a display unit according to an embodiment of this application;

FIG. 5 is a structural diagram of a second setting interface displayed on a display unit according to an embodiment of this application; and

FIG. 6 is a structural diagram of an electronic device according to an embodiment of this application.

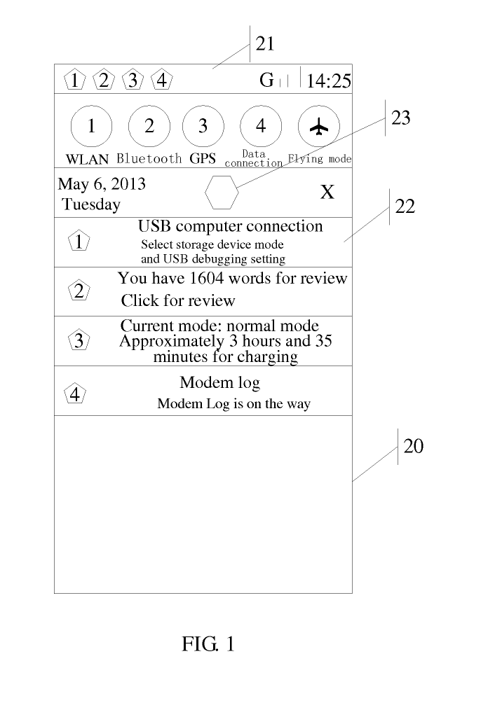

### DETAILED DESCRIPTION OF THE INVENTION

Embodiments of this application provide an information processing method and electronic device so as to address the technical problems of a single opening mode and troublesome operations when the existing electronic devices invoke a system setting interface and a system notification interface.

In order to address the foregoing technical problems, a general idea of a technical solution according to an embodiment of this application is as follows:

In the embodiment of this application, when status bar information is displayed on a display unit, and a display area of the status bar information is a first display area of the display unit, an input operation on the first display area is obtained, and when the input operation is a first input operation, a first notification interface including only prompt information is displayed on the display unit, and when the input operation is a second input operation, a second setting interface including only M application icons is displayed on the display unit, so that a user can view the first notification interface and the second setting interface through the different input operations, thereby addressing the technical problems of a single opening mode and troublesome operations when the existing electronic devices invoke a system setting interface and a system notification interface, and further achieving technical effects of invoking the system setting interface and the system notification interface in numerous modes and of simplifying operation steps, so that the user can make more convenient use and have a better experience thereof.

In order to better understand the foregoing technical solution, the foregoing technical solution will be detailed below with reference to the drawings and particular embodiments thereof.

An embodiment of this application provides an information processing method, applicable to an electronic device including a display unit, where status bar information is displayed on the display unit, and a display area of the status bar information is a first display area of the display unit, and the electronic device is, for example, a table computer, a smart phone, a notebook computer or another electronic device.

Particularly the display unit is, for example, a liquid crystal display screen, an LED touch screen, an LCD touch screen or another electronic device.

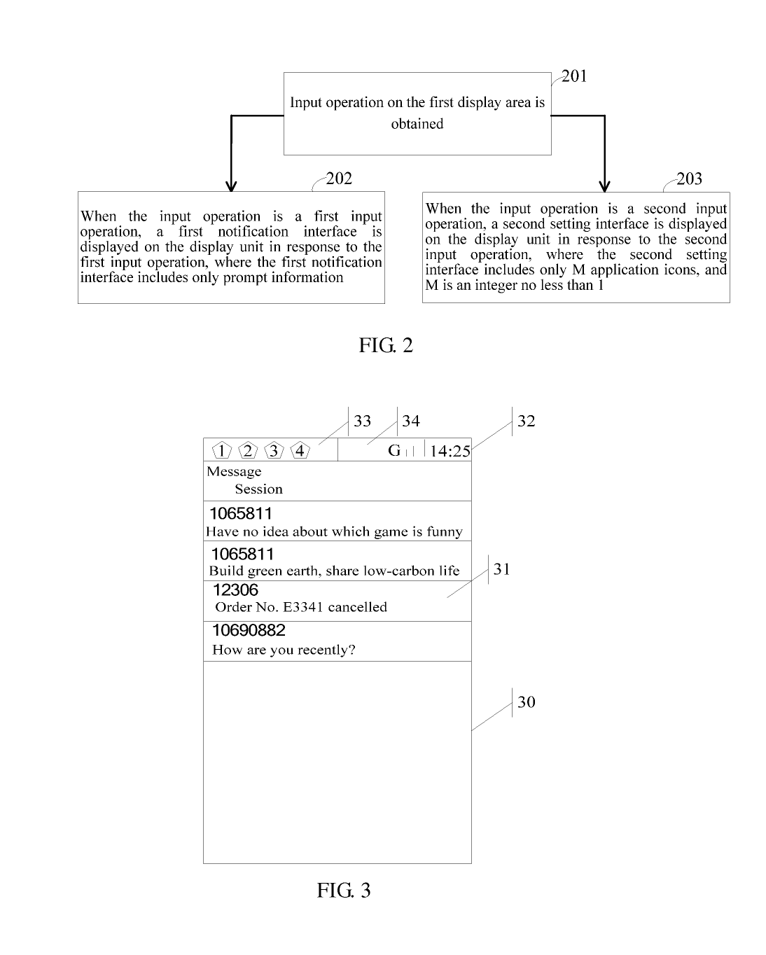

Referring to FIG. 2, this method includes:

Step 201: an input operation on the first display area is obtained;

Step 202: when the input operation is a first input operation, a first notification interface is displayed on the display unit in response to the first input operation, where the first notification interface includes only prompt information; and

Step 203: when the input operation is a second input operation, a second setting interface is displayed on the display unit in response to the second input operation, where the second setting interface includes only M application icons, and M is an integer no less than 1.

Particularly in the step 201, the input operation on the first display area is obtained.

In a particular implementation, when the display unit is in an enabled status, and the status bar information is displayed on the display unit, and the status information occupies the first display area of the display unit, the input operation on the first display area is obtained, where the input operation can be a specific gesture operation, for example, clockwise rotation of one round, counterclockwise rotation of one round or another specific gesture operation, to lower the probability of an improper operation.

Since the input operation is an operation on the status bar information displayed on the display unit, the input operation can be defined accurately to thereby lower the probability of an improper operation and further result in a better experience of a user.

Specifically, referring to FIG. 3, when a short message 31 is displayed on a touch screen 30 of a smart phone, a status bar 32 is displayed on an upper part of the touch screen 30, and a first display area of the status bar 32 is divided into a first part display area 33 and a second part display area 34, and a pull-down operation, a touch control operation or another input operation of the user on the first part display area 33 and the second part display area 34 is obtained.

When the input operation is the first input operation, the process proceeds with step 202 in which the first notification interface is displayed on the display unit in response to the first input operation, where the first notification interface includes only prompt information. In a particular implementation, when the input operation is the first input operation on the first part display area of the first display area, the first notification interface including system notification information is displayed on the display unit in response to the first input operation.

Particularly the prompt information can particularly be system notification information, for example, a missed call, an unread short message, software update information, etc.

Specifically the first display area is divided into at least two parts of display area, and when the input operation is an operation on the first part display area of the first display area, the input operation is the first input operation, and further the first notification interface is displayed on the display unit in response to the first input operation.

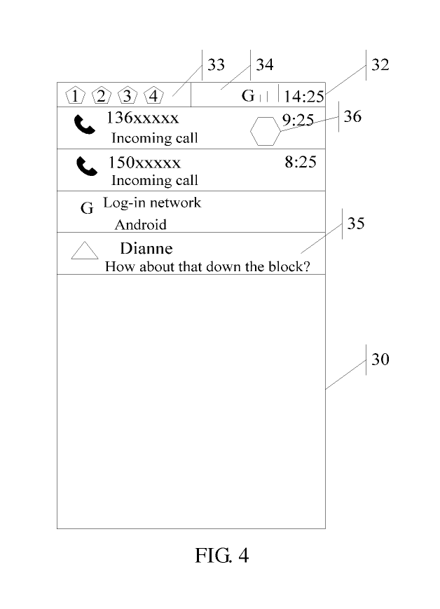

For example, referring to FIG. 3, when a graphic interface of a short message 31 is displayed on the touch screen 30 of the smart phone, a status bar 32 is displayed on an upper part of the touch screen 30, and a first display area of the status bar 32 is divided into a first part display area 33 and a second part display area 34, and when there is a pull-down operation of the user on the first part display area 33, the pull-down operation is the first input operation, and a system notification interface 35 is displayed on the graphic interface, particularly with reference to FIG. 4.

When the input operation is the second input operation, the process proceeds to the step 203 in which the second application interface is displayed on the display unit in response to the second input operation, where the second setting interface includes only M application icons, and M is an integer no less than 1. In a particular implementation, when the input operation is the second input operation on the second part display area of the first display area, the second setting interface is displayed on the display unit in response to the second input operation, where the second part display area is an area different from the first part display area.

Particularly since the step 202 and the step 203 are performed asynchronously, the step 203 is stopped while performing the step 202, and the step 202 is stopped while performing the step 203.

Specifically the first display area is divided into at least two parts of display area, and when the input operation is an operation on the first part display area of the first display area, the input operation is the first input operation, and further the first notification interface is displayed on the display unit in response to the first input operation; and when the input operation is an operation on the second part display area of the first display area, the input operation is the second input operation, and further the second system interface is displayed on the display unit in response to the second input operation.

Since the input operation on the first part display area is the first input operation, and the input operation on the second part display area is the second input operation, and the first part display area is an area different from the second part display area, thus the electronic device can recognize accurately the first input operation and the second input operation to lower the probability of an improper operation.

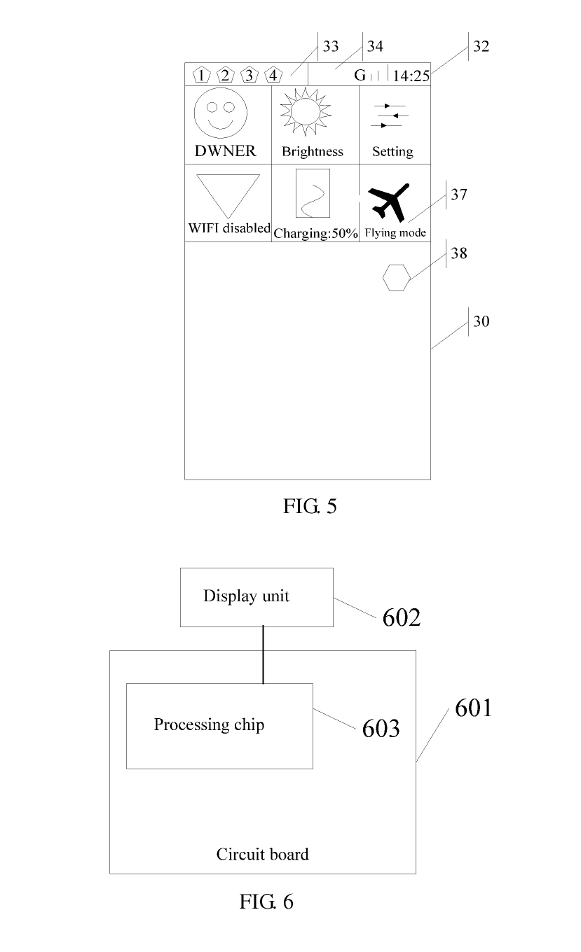

For example, with reference to FIG. 3, when a graphic interface of a short message 31 is displayed on the touch screen 30 of the smart phone, a status bar 32 is displayed on an upper part of the touch screen 30, and a first display area of the status bar 32 is divided into a first part display area 33 and a second part display area 34, and when there is a pull-down operation of the user on the second part display area 34, the pull-down operation is the second input operation, and a system setting interface 37 is displayed on the graphic interface, particularly with reference to FIG. 5, wherein the system setting interface 37 including a WIFI application icon, a charging application icon, an flying mode application icon and M application icons including setting application icons.

Of course, the first input operation can alternatively be an operation of clockwise rotation of a round on the first display area, the second input operation can alternatively be an operation of counterclockwise rotation of a round on the first display area, the first input operation can alternatively be an operation of leftward sliding on the first display area, or the second input operation can alternatively be an operation of rightward sliding on the first display area.

In another embodiment, after the first notification interface including the system notification information is displayed on the display unit, the method further includes: obtaining a first switching operation on the first notification interface; and adjusting the display interface of the display unit from the first notification interface to the second application interface in response to the first switching operation.

Particularly, the first switching operation can be an operation of pressing down a specific shortcut key or can alternatively be an operation of leftward or rightward sliding, and this application will not be limited in this respect although the following description will be given by taking a specific press key as an example.

Referring to FIG. 4, when the system notification interface 35 is displayed on the graphic interface, the detection of a press key 36 being pressed down indicates that the first switching operation has been obtained, and the current display interface displayed on the touch screen 30 is adjusted from the system notification interface 35 to the system setting interface 37, particularly with reference to FIG. 5.

Similarly, after the second system interface is displayed on the display unit, the method further includes: obtaining a second switching operation on the second application interface; and adjusting the display interface of the display unit from the second application interface to the first notification interface in response to the second switching operation.

Particularly the second switching operation can be an operation of pressing down a specific shortcut key or can alternatively be an operation of leftward or rightward sliding, and this application will not be limited in this respect although the following description will be given by taking a specific press key as an example.

Referring to FIG. 5, when the system setting interface 37 is displayed on the graphic interface, the detection of a press key 38 being pressed down indicates that the second switching operation has been obtained, and the current display interface displayed on the touch screen 30 is adjusted from the system setting interface 37 to the system notification interface 35, particularly with reference to FIG. 4.

Of course, the first display area of the status bar can alternatively be divided into 3 or 4 parts of display area, and these parts of display area can be operated on so that different types of messages are displayed on the graphic interface to thereby facilitate the use by the user.

In another embodiment, when the second application interface is displayed on the display unit, the method further includes: obtaining a first operation on a first application icon of the M application icons; and a setting interface of a first application corresponding to the first application icon is displayed on the display unit in response to the first operation.

For example, referring to FIG. 5, when the system setting interface 37 is displayed on the touch screen 30, since the system setting interface 37 includes a WIFI application icon, a charging application icon, an flying mode application icon and M application icons including setting application icons, when a click operation of the user on the flying mode application icon is detected, a setting interface of the flying mode is entered in response to the click operation, and the flying mode can be set as disabled or enabled on the setting interface, so that the user can make rapid setting and have a better experience thereof.

One or more of the technical solutions according to the embodiments of this application have at least the following technical effects or advantages:

Firstly, since in the embodiments of this application, the status bar information is displayed on the display unit, and when the display area of the status bar information is the first display area of the display unit, the input operation on the first display area is obtained, and when the input operation is the first input operation, the first notification interface including only the prompt information is displayed on the display unit, and when the input operation is the second input operation, the second setting interface including only the M application icons is displayed on the display unit, so that the user can view the first notification interface and the second setting interface through the different input operations, thereby addressing the technical problems of a single opening mode and troublesome operations when the existing electronic devices invoke a system setting interface and a system notification interface, and further achieving technical effects of invoking the system setting interface and the system notification interface in numerous modes and of simplifying operation steps, so that the user can make more convenient use and have a better experience thereof.

Secondly, since in the embodiments of the invention, when the input operation is the first input operation on the first part display area of the first display area, the first notification interface is displayed on the display unit, and when the input operation is the second input operation on the second part display area of the first display area, the second setting interface is displayed on the display unit, and the first part display area is different from the second part display area, thus the electronic device can recognize accurately the first input operation and the second input operation to lower the probability of an improper operation, so that the user can make more convenient use and have a better experience thereof.

Thirdly since in the embodiments of the invention, after the first notification interface is displayed on the display unit, the first switching operation is performed to adjust the current display interface of the display unit from the first notification interface to the second setting interface, so that switching between the first notification interface and the second setting interface can be performed simply with the first switching operation, and thereby numerous of opening modes are obtained, and thus the user can make more convenient use and have a better experience thereof.

An embodiment of this application provides an electronic device, which is, for example, a tablet computer, a smart phone, a notebook phone or another electronic device.

Referring to FIG. 6, the electronic device includes a circuit board 601; a display unit 602 electrically connected with the circuit board 601, configured to display status bar information, where the display area of the status bar information is a first display area of the display unit 602; and a processing chip 603 arranged on the circuit board 601, configured to obtain an input operation on the first display area, when the input operation is a first input operation, to display a first notification interface on the display unit in response to the first input operation, where the first notification interface includes only prompt information, and when the input operation is a second input operation, to display a second setting interface on the display unit in response to the second input operation, where the second setting interface includes only M application icons, and M is an integer no less than 1.

Particularly the circuit board 601 can be a main board of the electronic device, and furthermore the display unit 602 is, for example, a liquid crystal display screen, an LED touch screen, an LCD touch screen or another electronic device, and furthermore the processing chip 603 can be a single processing chip or can be integrated in a processor.

Furthermore the processing chip 603 includes a first obtaining unit configured, when the input operation is the first input operation on a first part display area of the first display area, to display the first notification interface including system notification information on the display unit 602 in response to the first input operation.

Furthermore the processing chip 603 includes a first switching unit configured, after the first notification interface including the system notification information is displayed on the display unit 602, to obtain a first switching operation on the first notification interface and to adjust the display interface of the display unit 602 from the first notification interface to the second application interface in response to the first switching operation.

Furthermore the processing chip 603 includes a second obtaining unit configured, when the input operation is the second input operation on a second part display area of the first display area, to display the second application interface on the display unit 602 in response to the second input operation, where the second part display area is an area different from the first part display area.

Furthermore the processing chip 603 includes a second switching unit configured, after the second application interface is displayed on the display unit 602, to obtain a second switching operation on the second application interface and to adjust the display interface of the display unit 602 from the second setting interface to the first notification interface in response to the second switching operation.

Furthermore the processing chip 603 includes a first processing unit configured, when the second setting interface is displayed on the display unit 602, to obtain a first operation on a first application icon of the M application icons and to display a setting interface of a first application corresponding to the first application icon on the display unit 602 in response to the first operation.

One or more of the technical solutions according to the embodiments of this application have at least the following technical effects or advantages:

Firstly, since in the embodiments of this application, the status bar information is displayed on the display unit, and when the display area of the status bar information is the first display area of the display unit, the input operation on the first display area is obtained, and when the input operation is the first input operation, the first notification interface including only the prompt information is displayed on the display unit, and when the input operation is the second input operation, the second setting interface including only the M application icons is displayed on the display unit, so that the user can view the first notification interface and the second setting interface through the different input operations, thereby addressing the technical problems of a single opening mode and troublesome operations when the existing electronic devices invoke a system setting interface and a system notification interface, and further achieving technical effects of invoking the system setting interface and the system notification interface in numerous modes and of simplifying operation steps, so that the user can make more convenient use and have a better experience thereof.

Secondly, since in the embodiments of the invention, when the input operation is the first input operation on the first part display area of the first display area, the first notification interface is displayed on the display unit, and when the input operation is the second input operation on the second part display area of the first display area, the second setting interface is displayed on the display unit, and since the first part display area is different from the second part display area, the electronic device can recognize accurately the first input operation and the second input operation to lower the probability of an improper operation, so that the user can make more convenient use and have a better experience thereof.

Thirdly, since in the embodiments of the invention, after the first notification interface is displayed on the display unit, the first switching operation is performed to adjust the current display interface of the display unit from the first notification interface to the second setting interface, so that switching between the first notification interface and the second setting interface can be performed simply with the first switching operation, thereby numerous of opening modes are obtained, and thus the user can make more convenient use and have a better experience thereof.

Although the preferred embodiments of the invention have been described, once obtaining the basic inventive concept, those skilled in the art can make additional modifications and variations to these embodiments. Therefore, the appended claims are intended to be construed as encompassing the preferred embodiments and all the modifications and variations coming into the scope of the invention.

Evidently those skilled in the art can make various modifications and variations to the invention without departing from the scope of the invention. Thus the invention is also intended to encompass these modifications and variations thereto so long as the modifications and variations come into the scope of the claims appended to the invention and their equivalents.

1. An information processing method, applicable to an electronic device having a display unit, wherein status bar information is displayed on the display unit, and a display area of the status bar information is a first display area of the display unit, and the method comprises:
obtaining an input operation on the first display area;
when the input operation is a first input operation, displaying a first notification interface on the display unit in response to the first input operation, wherein the first notification interface includes only prompt information; and
when the input operation is a second input operation, displaying a second setting interface on the display unit in response to the second input operation, wherein the second setting interface includes only M application icons, and M is an integer no less than 1.

2. The method according to claim 1, wherein when the input operation is the first input operation, the displaying the first notification interface on the display unit in response to the first input operation comprises:
when the input operation is the first input operation on a first part display area of the first display area, displaying the first notification interface including system notification information on the display unit in response to the first input operation.

3. The method according to claim 2, wherein after the first notification interface including the system notification information is displayed on the display unit, the method further comprises:
obtaining a first switching operation on the first notification interface; and
adjusting the display interface of the display unit from the first notification interface to the second setting interface in response to the first switching operation.

4. The method according to claim 1, wherein when the input operation is the second input operation, the displaying the second setting interface on the display unit in response to the second input operation comprises:
when the input operation is the second input operation on a second part display area of the first display area, displaying the second setting interface on the display unit in response to the second input operation, wherein the second part display area is an area different from the first part display area.

5. The method according to claim 4, wherein after the second setting interface is displayed on the display unit, the method further comprises:
obtaining a second switching operation on the second setting interface; and
adjusting the display interface of the display unit from the second setting interface to the first notification interface in response to the second switching operation.

6. The method according to claim 4, wherein when the second setting interface is displayed on the display unit, the method further comprises:
obtaining a first operation on a first application icon of the M application icons; and
displaying a setting interface of a first application corresponding to the first application icon on the display unit in response to the first operation.

7. An electronic device, comprising:
a circuit board;
a display unit, electrically connected with the circuit board, configured to display status bar information, wherein the display area of the status bar information is a first display area of the display unit; and
a processing chip, arranged on the circuit board, configured to obtain an input operation on the first display area, when the input operation is a first input operation, to display a first notification interface on the display unit in response to the first input operation, wherein the first notification interface includes only prompt information, and when the input operation is a second input operation, to display a second setting interface on the display unit in response to the second input operation, wherein the second setting interface includes only M application icons, and M is an integer no less than 1.

8. The electronic device according to claim 7, wherein the processing chip comprises a first obtaining unit configured, when the input operation is the first input operation on a first part display area of the first display area, to display the first notification interface including system notification information on the display unit in response to the first input operation.

9. The electronic device according to claim 8, wherein the processing chip comprises a first switching unit configured, after the first notification interface including the system notification information is displayed on the display unit, to obtain a first switching operation on the first notification interface and to adjust the display interface of the display unit from the first notification interface to the second setting interface in response to the first switching operation.

10. The electronic device according to claim 7, wherein the processing chip comprises a second obtaining unit configured, when the input operation is the second input operation on a second part display area of the first display area, to display the second setting interface on the display unit in response to the second input operation, wherein the second part display area is an area different from the first part display area.

11. The electronic device according to claim 10, wherein the processing chip comprises a second switching unit configured, after the second setting interface is displayed on the display unit, to obtain a second switching operation on the second setting interface and to adjust the display interface of the display unit from the second setting interface to the first notification interface in response to the second switching operation.

12. The electronic device according to claim 10, wherein the processing chip comprises a first processing unit configured, when the second setting interface is displayed on the display unit, to obtain a first operation on a first application icon of the M application icons and to display a setting interface of a first application corresponding to the first application icon on the display unit in response to the first operation.
